(19) United States
(12) Patent Application Publication
(10) Pub. No.: US 2011/0131647 A1
(43) Pub. Date: Jun. 2, 2011

(54) Virtual Endpoint Solution

(75) Inventors: Scott Sanders, Boulder, CO (US); Mark King, Vacaville, CA (US)

(73) Assignee: Scott Sanders, Boulder, CO (US)

(21) Appl. No.: 12/628,118

(22) Filed: Nov. 30, 2009

(51) Int. Cl. H04L 9/00; G06F 21/00; G06F 15/16

(52) U.S. Cl. 726/15; 709/227; 726/25

(57) ABSTRACT

A virtual endpoint solution to provides secure connectivity between a service provider network and the client network over the public Internet. This virtual private network (VPN) connection is fully routable from the service provider network to the client network and masqueraded on the client network to prevent any IP conflicts or routing issues. The virtualized endpoint allows for the VPN connection to be created without dedicated hardware or systems and able to run in almost any environment.

### BACKGROUND

1. Field

The present invention relates to providing remote access for security services such as vulnerability scans and penetration tests to internal networks of clients and/or subscribers and, more particularly, to providing full access to client internal networks without requiring dedicated hardware.

2. Related Art

In order to provide security services such as vulnerability scans and penetration tests of client devices, the system providing the service must be attached to and able to route over the client internal network in order to communicate with the client devices. This requires either the physical presence on the client network of the systems providing the service or a dedicated piece of physical hardware to provide such network connectivity between the service provider's network and the client's network. TCP/IP network routing is a complex issue and specific IP address ranges have been allocated for private use, which means that client networks are likely to overlap in terms of IP addresses used.

Remote network connectivity between a service provider and a client can be provided by dedicated physical devices that are placed on the client network which create a Virtual Private Network (VPN) connection back to the service provider to allow network access.

A second solution is to install the full systems needed to provide the security services onto the client network and let the client manage them or manage them remotely through a command-pull structure, where the systems will periodically check with the service provider to receive any new instructions or updates.

Installing physical systems on a client network is an economic hardship and resource intensive, as it can be cost-prohibitive and time-intensive to manufacture, supply, install and maintain such hardware and/or connectivity in order to provide security services to a client. Hardware or network connectivity failures will prevent the service from being provided, resulting in loss of revenue when contracts cannot be fulfilled.

Physical devices on a client network opening up a Virtual Private Network (VPN) connection back to the service provider are unable to determine if there are IP address overlaps or conflicts and are unable to resolve complicated network routes between the service provider and the client. Each installation must be uniquely configured to be sure that there are no IP address conflicts or overlaps.

### SUMMARY

In accordance with the present invention, there is provided a virtual endpoint that will provide connectivity between the service provider network and the client network when running without requiring dedicated hardware.

The systems at the service provider providing security services are addressed with Public IP Addresses to avoid any IP address or conflicts with client systems.

When started, the virtual endpoint acquires an IP address from the client network by DHCP (Dynamic Host Configuration Protocol), and can be assigned a static IP Address if necessary. This allows it full access to the client network and provides the ability to route across the client network.

A secure VPN (Virtual Private Network) Tunnel is created by the virtual endpoint on the client network to the network of the service provider. The endpoints of the VPN tunnel are statically assigned public IP Addresses reserved by the service provider.

The systems providing the security services are configured to use the statically assigned Virtual Endpoint IP address as the gateway to route to the IP of the target system, allowing them access to the client systems regardless of the IP addressing scheme used by the client.

The virtual endpoint is configured to accept any incoming traffic over the VPN tunnel from the service provider, masquerade the source IP address with the local address given by the client network and forward the traffic to the destination IP address on the client network. The client destination target will respond to the masqueraded IP provided by the virtual endpoint by sending the response back to the virtual endpoint. When the response reaches the virtual endpoint, it will reverse the masquerade by replacing the original source IP on the traffic and forward it through the VPN tunnel, allowing it to reach the original system on the service providers network.

It would be advantageous to provide a virtual endpoint to provide network connectivity between remote networks.

It would also be advantageous to provide a routing scheme for the virtual endpoint that will remove any possibility of IP Addressing conflicts or overlaps.

It would also be advantageous to provide a virtual endpoint that guarantees isolation between the client network and the service provider networks.

It would also be advantageous to provide a virtual endpoint that can be quickly disconnected and reconnected without harm by simply powering it on or off.

It would also be advantageous to provide a virtual endpoint that can be used across all clients without any reconfiguration for unique client networks.

It would further be advantageous to provide a virtual endpoint that requires no specialized skills or knowledge to use.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a FIG. 1 is a perspective view of the virtual endpoint solution, showing how separate networks can be connected through virtual endpoints; and

FIG. 2 is a detail view of a FIG. 2 is a detail view showing an example of the ip addressing scheme from the service provider network space through the client virtual endpoint to the client internal network space.

For purposes of clarity and brevity, like elements and components will bear the same designations and numbering throughout the Figures.

### DETAILED DESCRIPTION

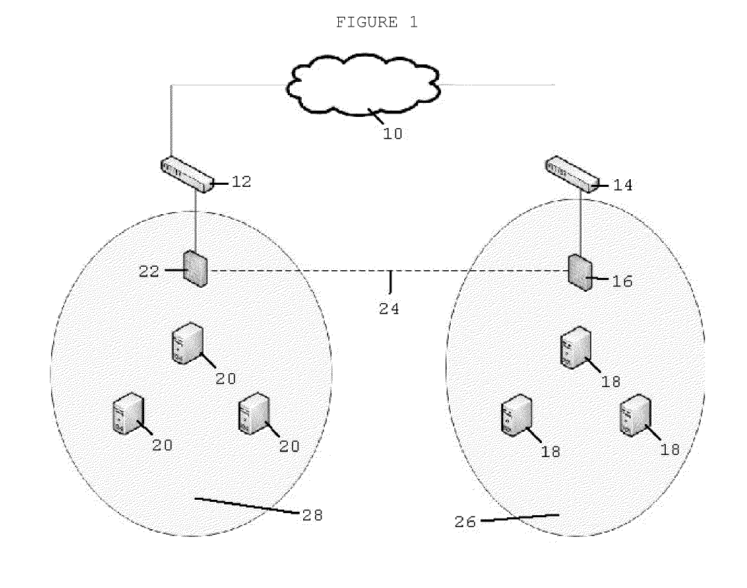

FIG. 1 is a perspective view of the virtual endpoint solution, showing how the service provider network can be connected to the client network through a virtual endpoint.

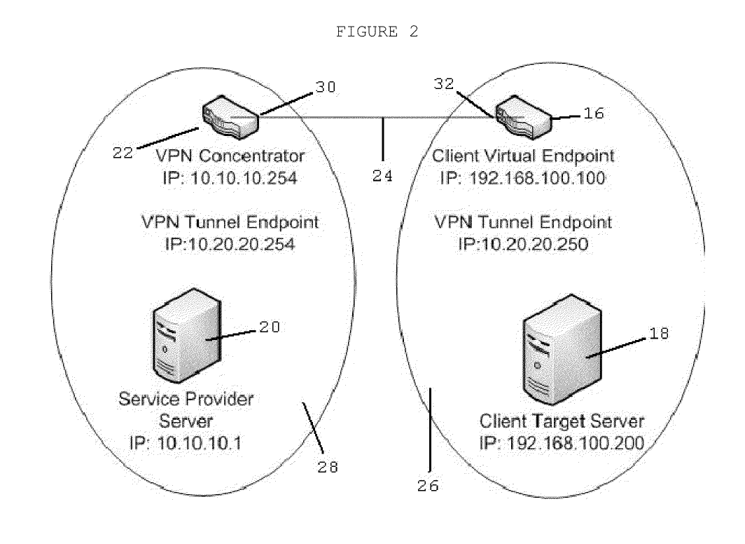

FIG. 2 is a detail view of a FIG. 2 is a detail view showing how the tcp/ip traffic from multiple networks routes through the virtual endpoints.

When started, the client virtual endpoint 16 acquires an IP address from the client internal network space 26 by DHCP (Dynamic Host Configuration Protocol), and can be assigned a static IP Address if necessary. This allows it full access to the client internal network space 26 and provides the ability to route across the client internal network space 26 and access to any routable client server 18 or system in the client internal network space 26.

A secure virtual private network connection 24 (VPN) is created by the client virtual endpoint 16 from the client internal network space 26 over the internet 10 through the client public interface 14 to the service provider public interface 12. The service provider public interface 12 routes the connection request to the virtual private network concentrator 22. The virtual private network concentrator 22 established the unique virtual private network connection 24 between the service provider network space 28 and the client virtual endpoint 16 on the client internal network space 26. The endpoints of the VPN tunnel are statically assigned public IP Addresses reserved by the service provider to prevent any routing conflicts.

The service provider server 20 providing the security services are configured to use the statically assigned Virtual Endpoint IP address as the gateway to route to the specific target IP address on the client network, allowing them access to the client systems regardless of the IP Addressing scheme used by the client.

The client virtual endpoint 16 is configured to accept any incoming traffic over the VPN tunnel from the service provider network space 28, masquerade the source IP address with the local IP address given by the client internal network space 26 and forward the traffic to the destination IP address of the client server 18 or system on the client internal network space 26. The client server 18 or system that has been selected as a target will respond to the masqueraded IP address provided by the client virtual endpoint 16 by sending the response back to the client virtual endpoint 16. When the response reaches the client virtual endpoint 16, it will reverse the masquerade by replacing the original source IP on the traffic and forward it through the virtual private network connection 24, allowing it to reach the original service provider server 20 on the service provider network space 28.

In FIG. 2, examples of a possible service provider network space 28 and client internal network space 26 configuration are shown. The service provider server 20 would send IP traffic to a target client server 18 (192.168.100.200) or system through the gateway designated as the service provider VPN tunnel endpoint 30 (10.20.20.254) and the traffic would be routed over the virtual private network connection 24 to the client VPN tunnel endpoint 32 (10.20.20.250) on the client virtual endpoint 16 (192.168.100.100). The client virtual endpoint 16 would accept the traffic, replace the originating source IP (10.10.10.1) from the service provider server 20 with its own IP (192.168.100.100) from the client internal network space 26 and route the traffic to the target, which is the client server 18 (192.168.100.200). The client server 18 (192.168.100.200) would see the current source IP on the packet (192.168.100.100) and send any responses back to the client virtual endpoint 16 (192.168.100.100). The client virtual endpoint 16 would receive the response, replace the original source IP (10.10.10.1) back on the traffic and route it through the client VPN tunnel endpoint 32 (10.20.20.250) and over the virtual private network connection 24 back to the service provider server 20 (10.10.10.1).

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A virtual endpoint solution for a virtual endpoint solution is for allowing security service providers access to client internal networks without requiring dedicated hardware, comprising:
means for connection between the public internet and the private service provider network;
means for connection of the client private network to the public internet;
means for connection of the client network to the service provider network through a virtual private network created over the public internet;
means for accepting and establishing incoming virtual private network connections from virtual endpoints and routing traffic to and from appropriate service provider systems back to the appropriate virtual endpoint;
means for providing connectivity directly between the service provider internal network and the client internal network;
means for providing private network space for client systems, locally connected to said means for connection of the client network to the service provider network through a virtual private network created over the public internet, and functionally connected to said means for connection of the client private network to the public internet;
means for providing private network space for service provider systems, locally connected to said means for accepting and establishing incoming virtual private network connections from virtual endpoints and routing traffic to and from appropriate service provider systems back to the appropriate virtual endpoint, and functionally connected to said means for connection between the public internet and the private service provider network;
means for providing an established ip connection and gateway to the client internal network space, rigidly connected to said means for providing connectivity directly between the service provider internal network and the client internal network, and functionally connected to said means for accepting and establishing incoming virtual private network connections from virtual endpoints and routing traffic to and from appropriate service provider systems back to the appropriate virtual endpoint; and
means for providing an established ip connection and gateway to the service provider internal network space, rigidly connected to said means for providing connectivity directly between the service provider internal network and the client internal network, and rigidly connected to said means for connection of the client network to the service provider network through a virtual private network created over the public internet.

2. The virtual endpoint solution in accordance with claim 1, wherein said means for connection between the public internet and the private service provider network comprises a public ip address, private ip address, ability to translate between public and private ip ranges service provider public interface.

3. The virtual endpoint solution in accordance with claim 1, wherein said means for connection of the client private network to the public internet comprises a public ip address, private ip address, ability to translate between public and private ip networks client public interface.

4. The virtual endpoint solution in accordance with claim 1, wherein said means for connection of the client network to the service provider network through a virtual private network created over the public internet comprises an ip address on client private network, ability to connect to the public internet client virtual endpoint.

5. The virtual endpoint solution in accordance with claim 1, wherein said means for accepting and establishing incoming virtual private network connections from virtual endpoints and routing traffic to and from appropriate service provider systems back to the appropriate virtual endpoint comprises an ip address on service provider network, ability to accept and route multiple virtual private network tunnels to different targets virtual private network concentrator.

6. The virtual endpoint solution in accordance with claim 1, wherein said means for providing connectivity directly between the service provider internal network and the client internal network comprises an ip gateway address on service provider network, ip address on client internal network virtual private network connection.

7. The virtual endpoint solution in accordance with claim 1, wherein said means for providing private network space for client systems comprises a private ip address ranges client internal network space.

8. The virtual endpoint solution in accordance with claim 1, wherein said means for providing private network space for service provider systems comprises a private ip address ranges service provider network space.

9. The virtual endpoint solution in accordance with claim 1, wherein said means for providing an established ip connection and gateway to the client internal network space comprises a service provider vpn tunnel endpoint.

10. The virtual endpoint solution in accordance with claim 1, wherein said means for providing an established ip connection and gateway to the service provider internal network space comprises a client vpn tunnel endpoint.

11. A virtual endpoint solution for a virtual endpoint solution is for allowing security service providers access to client internal networks without requiring dedicated hardware, comprising:
a public ip address, private ip address, ability to translate between public and private ip ranges service provider public interface, for connection between the public internet and the private service provider network;
a public ip address, private ip address, ability to translate between public and private ip networks client public interface, for connection of the client private network to the public internet;
an ip address on client private network, ability to connect to the public internet client virtual endpoint, for connection of the client network to the service provider network through a virtual private network created over the public internet;
an ip address on service provider network, ability to accept and route multiple virtual private network tunnels to different targets virtual private network concentrator, for accepting and establishing incoming virtual private network connections from virtual endpoints and routing traffic to and from appropriate service provider systems back to the appropriate virtual endpoint;
an ip gateway address on service provider network, ip address on client internal network virtual private network connection, for providing connectivity directly between the service provider internal network and the client internal network;
a private ip address ranges client internal network space, for providing private network space for client systems, locally connected to said client virtual endpoint, and functionally connected to said client public interface;
a private ip address ranges service provider network space, for providing private network space for service provider systems, locally connected to said virtual private network concentrator, and functionally connected to said service provider public interface;
a service provider vpn tunnel endpoint, for providing an established ip connection and gateway to the client internal network space, rigidly connected to said virtual private network connection, and functionally connected to said virtual private network concentrator; and
a client vpn tunnel endpoint, for providing an established ip connection and gateway to the service provider internal network space, rigidly connected to said virtual private network connection, and rigidly connected to said client virtual endpoint.

12. The virtual endpoint solution as recited in claim 11, further comprising:
a private ip address on client network client server, for to represent a possible target for the security assessment conducted by the service provider, transversely connected to said client virtual endpoint, and locally connected to said client internal network space.

13. The virtual endpoint solution as recited in claim 11, further comprising:
an ip address on service provider internal network, ability to route traffic through the vpn concentrator service provider server, for providing the security assessment services to the client, locally connected to said service provider network space, and transversely connected to said service provider VPN tunnel endpoint.

14. The virtual endpoint solution as recited in claim 12, further comprising:
an ip address on service provider internal network, ability to route traffic through the vpn concentrator service provider server, for providing the security assessment services to the client, locally connected to said service provider network space, and transversely connected to said service provider VPN tunnel endpoint.

15. A virtual endpoint solution for a virtual endpoint solution is for allowing security service providers access to client internal networks without requiring dedicated hardware, comprising:
a public ip address, private ip address, ability to translate between public and private ip ranges service provider public interface, for connection between the public internet and the private service provider network;
a public ip address, private ip address, ability to translate between public and private ip networks client public interface, for connection of the client private network to the public internet;
an ip address on client private network, ability to connect to the public internet client virtual endpoint, for connection of the client network to the service provider network through a virtual private network created over the public internet;
a private ip address on client network client server, for to represent a possible target for the security assessment conducted by the service provider, transversely connected to said client virtual endpoint;
an ip address on service provider internal network, ability to route traffic through the vpn concentrator service provider server, for providing the security assessment services to the client;
an ip address on service provider network, ability to accept and route multiple virtual private network tunnels to different targets virtual private network concentrator, for accepting and establishing incoming virtual private network connections from virtual endpoints and routing traffic to and from appropriate service provider systems back to the appropriate virtual endpoint;
an ip gateway address on service provider network, ip address on client internal network virtual private network connection, for providing connectivity directly between the service provider internal network and the client internal network;
a private ip address ranges client internal network space, for providing private network space for client systems, locally connected to said client server, locally connected to said client virtual endpoint, and functionally connected to said client public interface;
a private ip address ranges service provider network space, for providing private network space for service provider systems, locally connected to said virtual private network concentrator, locally connected to said service provider server, and functionally connected to said service provider public interface;
a service provider vpn tunnel endpoint, for providing an established ip connection and gateway to the client internal network space, rigidly connected to said virtual private network connection, functionally connected to said virtual private network concentrator, and transversely connected to said service provider server; and
a client vpn tunnel endpoint, for providing an established ip connection and gateway to the service provider internal network space, rigidly connected to said virtual private network connection, and rigidly connected to said client virtual endpoint.
